(19) United States
(12) Patent Application Publication
(10) Pub. No.: US 2025/0353953 A1
(43) Pub. Date: Nov. 20, 2025

(54) CONTINUOUS PRODUCTION OF BIODEGRADABLE POLYESTERS

(71) Applicant: Intrinsic Advanced Materials, LLC, Gastonia, NC (US)

(72) Inventors: Robert A. USHER, JR., Charlotte, NC (US); Julia R. LOGAN, Charlotte, NC (US)

(73) Assignee: Intrinsic Advanced Materials, LLC, Gastonia, NC (US)

(21) Appl. No.: 18/862,832

(22) PCT Filed: May 4, 2022
(86) PCT No.: PCT/US2022/027660

§ 371 Date: Nov. 4, 2024

(51) Int. Cl. C08G 63/183; D01D 5/08; D01F 6/92; D02G 3/04; D03D 15/283; D04H 1/435

(52) U.S. Cl. CPC C08G 63/183; D01D 5/08; D01F 6/92; D02G 3/04; D03D 15/283; D04H 1/435; C08G 2230/00; D10B 2331/04; D10B 2401/12

(57) ABSTRACT

A method is disclosed for spinning a biodegradable polyester copolymer filament. A biodegradable polyester copolymer melt is formed by polymerizing terephthalic acid, ethylene glycol, caprolactone monomer, calcium carbonate, and poly butylene succinate to form a biodegradable polyester copolymer melt. The biodegradable polyester copolymer melt may be spun into a biodegradable polyester copolymer filament.

### FIELD

The presently-disclosed invention relates generally to polymer compositions suitable for textiles and that are biodegradable.

### BACKGROUND

Textiles are fundamental to human culture and have been made and used by humans for thousands of years. The earliest known textiles were woven from natural fibers such as flax, wool, silk, and cotton. More recently, textile fibers, yarns and fabrics also have been industrially produced from polymers, such as polyester, nylon olefins, other thermoplastic polymers, and combinations thereof. Many modern polymers can be made into an almost endless variety of shapes and products that are attractive, durable, and water-resistant. In many cases these synthetic fibers or yarns (depending upon the desired technique and end product) can be blended with natural fibers to obtain end products with desired features of both natural and synthetic materials.

Although durability and water-resistance are desirable, these same properties can lead to secondary environmental problems. Textiles produced from polymeric fibers do not naturally biodegrade in the same manner as natural fibers, and can remain in landfills and water (e.g., lakes, oceans) for hundreds of years or more.

Biodegradable fibers currently available further present various issues in their manufacture. Typically, to form biodegradable polymers, a masterbatch approach is used with an extruder process to form biodegradable polymers. However, masterbatch is costly, requiring additional compounding, drying and crystallization steps. Further, polycaprolactone (Mw of 6400), a known biodegradable polymer, in pellet form is well suited to a masterbatch approach, however it is more difficult to use in continuous polymerization process.

Accordingly, there is a need for biodegradable polymers suitable for forming textiles with desirable properties analogous to traditional textiles, which may be formed via continuous production (i.e., continuous polymerization), rather than masterbatch production.

### BRIEF SUMMARY

In one aspect, a method is provided for spinning a biodegradable polyester copolymer filament. The method comprises polymerizing terephthalic acid, ethylene glycol, caprolactone monomer, calcium carbonate, and polybutylene succinate to form a biodegradable polyester copolymer melt. The biodegradable polyester copolymer melt is then spun into a biodegradable polyester copolymer filament.

In another aspect, a biodegradable textile composition is disclosed, comprising terephthalic acid, ethylene glycol, caprolactone monomer, calcium carbonate and polybutylene succinate.

In yet another aspect, a biodegradable polyester copolymer filament comprising terephthalic acid, ethylene glycol, caprolactone monomer, calcium carbonate and polybutylene succinate is disclosed.

### BRIEF DESCRIPTION OF THE DRAWINGS

The foregoing and other advantages of the present invention may become apparent upon reviewing the following detailed description and drawings of non-limiting examples of embodiments in which:

FIG. 1 is a table of additive components and associated levels in overhead and vacuum.

FIG. 2 shows the results of a standard test method for determining anaerobic biodegradation of plastic materials under high-solids anaerobic-digestion conditions evaluating materials of the present disclosure at 296 days.

FIG. 3 shows the results of a standard test method for determining anaerobic biodegradation of plastic materials under high-solids anaerobic-digestion conditions evaluating materials of the present disclosure at 298 days.

FIG. 4 shows the results of a standard test method for determining anaerobic biodegradation of plastic materials under high-solids anaerobic-digestion conditions evaluating materials of the present disclosure at 305 days.

FIG. 5 is a graph of biodegradation of materials of the present disclosure as compared to positive and negative controls from 0-305 days.

FIG. 6 is a graph of biodegradation of materials of the present disclosure as compared to a negative control from 0-305 days.

FIG. 7 is a table showing amounts of components of a polyester fiber of the present disclosure.

### DETAILED DESCRIPTION

As set forth herein, the present disclosure describes fibers with desirable properties analogous to traditional fibers that are biodegradable and which may be formed via continuous production, rather than masterbatch production. More particularly, a polyester (polyethylene terephthalate or PET) fiber that is biodegradable is disclosed.

The invention now will be described more fully with reference to the accompanying drawings, in which some, but not all embodiments of the inventions are shown. This invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

As used herein, the term “biodegradable” means materials that when given the right natural conditions and presence of microorganisms, will decompose, or break down to its basic components and blend back in with the earth on a significantly faster scale than non-biodegradable materials.

As used herein, in the context of synthetic fibers and their manufacture, the term “intrinsic viscosity” is used to describe a characteristic that is directly proportional to the average molecular weight of a polymer. Intrinsic viscosity is calculated on the basis of the viscosity of a polymer solution (in a solvent) extrapolated to a zero concentration.

In the textile arts, the term “texturing” is used both broadly and specifically. In the broadest sense, texturing is used as a synonym to refer to steps in which synthetic filament, staple fiber, or yarn is mechanically treated, thermally treated, or both, to have a greater volume then the untreated filament, staple, or yarn. In a narrower sense, the term texturing is used to refer to treatments that produce looping and curling. The meaning is generally clear in context. As used herein, the word “texture” is used in a broad sense to include all possibilities for producing the desired effect in a filament, staple fiber, or yarn.

Where “between” is used to indicate a number range, the range is inclusive of the numbers used. For example, “between about 10% and about 13%” is inclusive of both 10% and 13% as well as all numbers between 10% and 13%.

As used herein, “percent” or “%” means weight percent unless otherwise specified. Further, concentrations and proportions, unless otherwise stated, refer to the concentration or proportion in the finished copolymer.

Accordingly, a polyester (polyethylene terephthalate) fiber that is biodegradable is described. Typically, to form biodegradable polymers, a masterbatch approach is used with an extruder process. However, masterbatch is costly, requiring additional compounding, drying and crystallization steps, and is thus poorly adopted and biodegradable fibers are not widely available at affordable price points. A continuous polymerization process is more economical for synthesis of polyesters, however, polycaprolactone (Mw of 6400), a known biodegradable polymer, is in pellet form and is well suited to a masterbatch approach but is ill-adapted for use in continuous polymerization process.

To overcome these difficulties, the present disclosure incorporates caprolactone monomer, a clear liquid, into polyester in a continuous polymerization process. Caprolactone monomer is a precursor to polycaprolactone, which is biodegradable in a natural environment, and imparts other desirable properties into the fiber, such as dye enhancement. The use of caprolactone monomer on conventional continuous polymerization lines results in high throughput with low cost, with outputs exceeding 30,000 pounds per hour, or sometimes about 40,000 pounds per hour or even 60,000 to 90,000 pounds per hour, as compared to a masterbatch approach which limits production throughput to around 2,000 pounds per hour.

Further, the caprolactone monomer is nearly fully consumed, or approximately fully consumed (e.g., values less than 200 ppm).

To produce the biodegradable polymers of the present disclosure, terephthalic acid (or purified terephthalic acid or PTA) and ethylene glycol (or monoethylene glycol or MEG) are reacted in a heated esterification reaction to produce monomers and oligomers of terephthalic acid and ethylene glycol as well as water as a byproduct. The esterification reaction may be carried out in one or more vessels, in some embodiments two vessels are used, each an estifier. A pressure gradient is conventionally used to drive the continuous polymerization process. Additionally, pumps may be used to drive the process. To enable the esterification reaction to go essentially to completion, water and MEG are continuously removed. The monomers and oligomers formed via esterification are subsequently catalytically polymerized via polycondensation to form polyethylene terephthalate (or PET) polyester. The polycondensation reactions may be carried out in one or more vessels, each a polymerizer. In some embodiments, two vessels are used, a low polymerizer under low vacuum and a high polymerizer under high vacuum, as is known in the art.

Caprolactone monomer and calcium carbonate (CaCO₃) are added during the above esterification and polycondensation reactions. In some embodiments, the caprolactone monomer and calcium carbonate may be added directly to the vessel containing the condensation product, e.g., a low polymerizer. In some embodiments, the caprolactone monomer and calcium carbonate may be added to a transfer line between an esterifier and a polymerizer. In a subsequent step, polybutylene succinate (PBS) is added. The reactions typically proceed at about 280° C. (e.g., between about 270° C. and 295° C.). Caprolactone monomer is incorporated into the polyester fiber along with PBS and calcium carbonate to form a biodegradable polyester material. Microbes digest the resulting fiber containing polycaprolactone, PBS and calcium carbonate to break down the polymer chains and allow the fibers to biodegrade.

The polymerization of terephthalic acid, ethylene glycol, caprolactone monomer, calcium carbonate, and polybutylene succinate may comprise polymerizing from about 83% to about 86% terephthalic acid by weight of the biodegradable polyester copolymer melt. From about 13% to about 16% ethylene glycol by weight of the biodegradable polyester copolymer melt may be used. From about 0.3% to about 2.5% caprolactone monomer by weight of the biodegradable polyester copolymer melt may be used. From about 0.01% to about 0.03% calcium carbonate by weight of the biodegradable polyester copolymer melt may be used. From about 0.05% to about 0.25% polybutylene succinate by weight of the biodegradable polyester copolymer melt may be used, and points therebetween.

Those having ordinary skill in the art recognize that other kinds of additives can be incorporated into the polymers of the present invention. By way of non-limiting example, anatase titanium dioxide, one or more optical brighteners, and blue pigment may be added. Such additives include, without limitation, delusterants, preform heat-up rate enhancers, friction-reducing additives, UV absorbers, inert particulate additives (e.g., clays or silicas), colorants, pigments, antioxidants, branching agents, oxygen barrier agents, carbon dioxide barrier agents, oxygen scavengers, flame retardants, crystallization control agents, acetaldehyde reducing agents, impact modifiers, catalyst deactivators, melt strength enhancers, anti-static agents, lubricants, chain extenders, nucleating agents, solvents, fillers, and plasticizers.

In embodiments where 83-86% terephthalic acid is disclosed, the concentration of terephthalic acid may be between about 83% and about 83.1%, between about 83% and about 83.2%, between about 83% and about 83.3%, between about 83% and about 83.4%, between about 83% and about 83.5%, between about 83% and about 83.6%, between about 83% and about 83.7%, between about 83% and about 83.8%, between about 83% and about 83.9%, between about 83% and about 84%, between about 83% and about 84.1%, between about 83% and about 84.2%, between about 83% and about 84.3%, between about 83% and about 84.4%, between about 83% and about 84.6%, between about 83% and about 84.7%, between about 83% and about 84.8%, between about 83% and about 84.9%, between about 83% and about 85%, between about 84% and about 85%, between about 84% and about 85.1%, between about 84% and about 85.2%, between about 84% and about 85.3%, between about 84% and about 85.4%, between about 84% and about 85.6%, between about 84% and about 85.7%, between about 84% and about 85.8%, between about 84% and about 85.9%, between about 84% and about 86%, between about 85.9% and about 86%, between about 85.8% and about 86%, between about 85.7% and about 86%, between about 85.6% and about 86%, between about 85.5% and about 86%, between about 85.4% and about 86%, between about 85.3% and about 86%, between about 85.2% and about 86%, between about 85.1% and about 86%, between about 85% and about 86%, between about 84.9% and about 86%, between about 84.8% and about 86%, between about 84.7% and about 86%, between about 84.6% and about 86%, between about 84.3% and about 86%, between about 84.2% and about 86%, between about 84.1% and about 86%, and/or between about 84% and about 86% and points therebetween.

In embodiments where 13-16% ethylene glycol is disclosed, the concentration of ethylene glycol may be between about 13% and about 13.1% ethylene glycol, between about 13% and about 13.2%, between about 13% and about 13.3%, between about 13% and about 13.4%, between about 13% and about 13.5%, between about 13% and about 13.6%, between about 13% and about 13.7%, between about 13% and about 13.8%, between about 13% and about 13.9%, between about 13% and about 14%, between about 13% and about 14.1%, between about 13% and about 14.2%, between about 13% and about 14.3%, between about 13% and about 14.4%, between about 13% and about 14.5%, between about 13% and about 14.6%, between about 13% and about 14.7%, between about 13% and about 14.8%, between about 13% and about 14.9%, between about 13% and about 15%, between about 13% and about 15.1%, between about 13% and about 15.2%, between about 13% and about 15.3%, between about 13% and about 15.4%, between about 13% and about 15.5%, between about 13% and about 15.6%, between about 13% and about 15.7%, between about 13% and about 15.8%, between about 13% and about 15.9%, between about 13% and about 16%, between about 13.1% and about 16%, between about 13.2% and about 16%, between about 13.3% and about 16%, between about 13.4% and about 16%, between about 13.5% and about 16%, between about 13.6% and about 16%, between about 13.7% and about 16%, between about 13.8% and about 16%, between about 13.9% and about 16%, between about 14% and about 16%, between about 14.1% and about 16%, between about 14.2% and about 16%, between about 14.3% and about 16%, between about 14.4% and about 16%, between about 14.5% and about 16%, between about 14.6% and about 16%, between about 14.7% and about 16%, between about 14.8% and about 16%, between about 14.9% and about 16%, between about 15% and about 16%, between about 15.1% and about 16%, between about 15.2% and about 16%, between about 15.3% and about 16%, between about 15.4% and about 16%, between about 15.5% and about 16%, between about 15.6% and about 16%, between about 15.7% and about 16%, between about 15.8% and about 16%, and/or between about 15.9% and about 16% and points therebetween.

In embodiments where 0.3-2.5% caprolactone monomer is disclosed, the concentration of caprolactone monomer may be between about 0.3% and about 0.4%, between about 0.3% and about 0.4%, between about 0.3% and about 0.6%, between about 0.3% and about 0.7%, between about 0.3% and about 0.8%, between about 0.3% and about 0.9%, between about 0.3% and about 1.0%, between about 0.3% and about 1.1%, between about 0.3% and about 1.2%, between about 0.3% and about 1.3%, between about 0.3% and about 1.4%, between about 0.3% and about 1.5%, between about 0.3% and about 1.6%, between about 0.3% and about 1.7%, between about 0.3% and about 1.8%, between about 0.3% and about 1.9%, between about 0.3% and about 2.0%, between about 0.3% and about 2.1%, between about 0.3% and about 2.2%, between about 0.3% and about 2.3%, between about 0.3% and about 2.4%, between about 0.3% and about 2.5%, between about 0.4% and about 2.5%, between about 0.5% and about 2.5%, between about 0.6% and about 2.5%, between about 0.7% and about 2.5%, between about 0.8% and about 2.5%, between about 0.9% and about 2.5%, between about 1.0% and about 2.5%, between about 1.1% and about 2.5%, between about 1.2% and about 2.5%, between about 1.3% and about 2.5%, between about 1.4% and about 2.5%, between about 1.5% and about 2.5%, between about 1.6% and about 2.5%, between about 1.7% and about 2.5%, between about 1.8% and about 2.5%, between about 1.9% and about 2.5%, between about 2.0% and about 2.5%, between about 2.1% and about 2.5%, between about 2.2% and about 2.5%, between about 2.3% and about 2.5%, and/or between about 2.4 and about 2.5% and points therebetween.

In embodiments where 0.01-0.03% calcium carbonate is disclosed, the concentration of calcium carbonate may be between about 0.01% and about 0.02%, or from about 0.02% to about 0.03%, and points therebetween.

In embodiments where 0.05-0.25% polybutylene succinate is disclosed, the concentration of polybutylene succinate may be between about 0.05% and about 0.06%, between about 0.05% and about 0.07%, between about 0.05% and about 0.08%, between about 0.05% and about 0.09%, between about 0.05% and about 0.1%, between about 0.05% and about 0.11%, between about 0.05% and about 0.12%, between about 0.05% and about 0.13%, between about 0.05% and about 0.14%, between about 0.05% and about 0.15%, between about 0.05% and about 0.16%, between about 0.05% and about 0.17%, between about 0.05% and about 0.18%, between about 0.05% and about 0.19%, between about 0.05% and about 0.20%, between about 0.05% and about 0.21%, between about 0.05% and about 0.22%, between about 0.05% and about 0.23%, between about 0.05% and about 0.24%, between about 0.05% and about 0.25%, between about 0.24% and about 0.25%, between about 0.23% and about 0.25%, between about 0.22% and about 0.25%, between about 0.21% and about 0.25%, between about 0.20% and about 0.25%, between about 0.19% and about 0.25%, between about 0.18% and about 0.25%, between about 0.17% and about 0.25%, between about 0.16% and about 0.25%, between about 0.15% and about 0.25%, between about 0.14% and about 0.25%, between about 0.13% and about 0.25%, between about 0.12% and about 0.25%, between about 0.11% and about 0.25%, between about 0.1% and about 0.25%, between about 0.09% and about 0.25%, between about 0.08% and about 0.25%, between about 0.07% and about 0.25%, and/or between about 0.06% and about 0.25%, and points therebetween.

Polymerization continues until the desired mole weight of polyester terephthalate is achieved. The residence time in the polymerization vessels and the feed rate of the ethylene glycol and terephthalic acid into the continuous process is determined, in part, based on the target molecular weight of the polyester. As the molecular weight can be determined by the intrinsic viscosity of the polymer melt, the intrinsic viscosity of the polymer melt is generally used to determine polymerization conditions, such as temperature, pressure, the feed rate of the reactants, and the residence time within the polymerization vessels.

Upon completion of the polycondensation stage, the polymer melt may be filtered and extruded. After extrusion, the polyethylene terephthalate is quenched to solidify the polyester, such as by spraying with water. The solidified polyethylene terephthalate may be cut into chips for storage and handling purposes.

In some embodiments, the polyester produced by the method is spun into a filament using conventional techniques known in the art.

In some embodiments, the polyester produced by the method may be blow molded into packaging and other products.

In some embodiments, the filament produced by the method is textured and cut into staple fiber. Texturing is well understood in the art and will not be otherwise described in detail, other than to point out that to date, the composition of the invention produces filament that can be textured using conventional steps (e.g., heat setting while in a twisted position).

In some embodiments, the staple fiber produced by the method is spun into a yarn.

In some embodiments, the staple fiber may be laid in a nonwoven batt.

In some embodiments, the staple fiber is spun into a blended yarn with cotton or rayon. The yarn may then be used to form a fabric which can be used to create textiles such as garments and the like. The fabric may be woven or knitted, and such fabric used to create textiles and garments. Similarly, the nonwoven batt may be used to form a fabric or textile to create garments and the like.

The resulting fibers, filaments, fabrics, containers and the like are biodegradable in a landfill environment, ocean environment, sewer sludge, and in sea water and fresh water, as well as other natural and unnatural environments that comprise microbes. The time scale of biodegradation in exemplary embodiments are comparable to the biodegradation time scales of natural fibers. In some embodiments, degradation of fiber or fabric of the present disclosure is substantially or mostly complete at 3-4 years. In some or other embodiments, degradation of fiber or fabric of the present disclosure is substantially or mostly complete at less than 3 years.

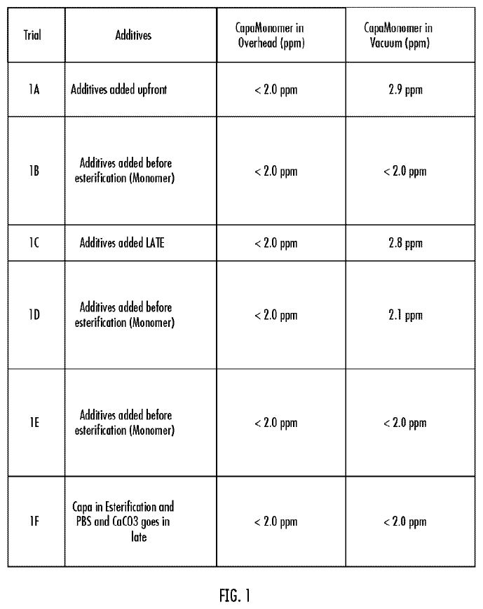

Turning now to the figures, FIG. 1 is a table of additive components and associated levels in overhead and vacuum. Six trials are shown, with additives added at various steps of the polyester synthesis process, including upfront, before esterification, and with Capa added in esterification, while polybutylene succinate (PBS) and calcium carbonate (CaCO₃) are added late.

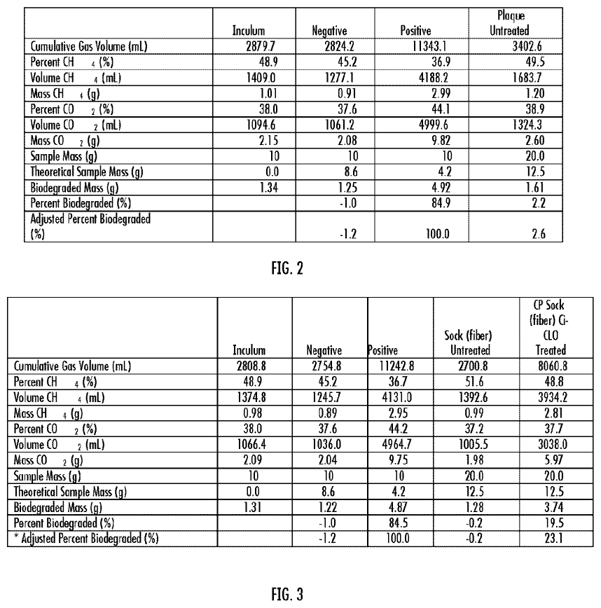

FIG. 2 illustrates an ASTM D5511 study, a standard test method for determining anaerobic biodegradation of plastic materials under high-solids anaerobic-digestion conditions, evaluating a sample of the present disclosure at 296 Days. Cellulose is used as a positive control for purposes of the adjusted percent biodegradation, under the assumption that cellulose will fully biodegrade. The negative control is polypropylene. All values have been proportionally adjusted relative to the cellulose degradation.

FIG. 3 illustrates an ASTM D5511 study for a sample at 298 Days. Again, cellulose is used as a positive control.

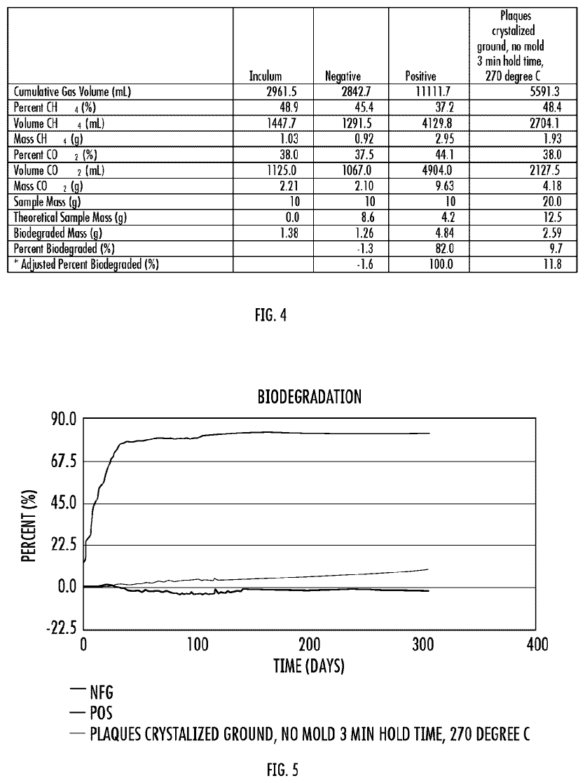

FIG. 4 illustrates an ASTM D5511 study for a sample at 305 Days, with cellulose as a positive control.

FIG. 5 is a chart of biodegradation plotted to 305 days, with the positive control showing the greatest degradation (top line), and the negative control showing no degradation (bottom line). As shown, degradation of an embodiment of the present disclosure, plaques crystalized ground, no mold 3 minute hold time at 270° C., shows increasing biodegradation over time (middle line).

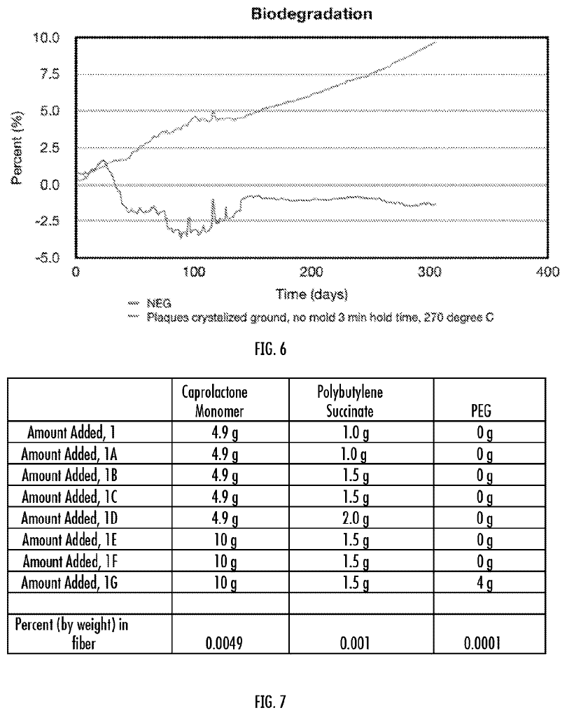

FIG. 6 is a chart of biodegradation plotted to 305 days, comparing degradation of embodiments of the present disclosure (top line) versus a negative control (polypropylene, bottom line). The compositions of the present disclosure show increasing biodegradation over time.

FIG. 7 is a table showing amounts of components of a polyester fiber of the present disclosure.

### EXAMPLES

The following non-limiting examples are provided to illustrate the disclosure.

### Example 1

In this example, a 1000 g portion of biodegradable polyethylene terephthalate is continually produced. The 1000 g portion is formed by adding about 850 g of terephthalic acid and a stoichiometric amount of ethylene glycol to an esterifier; adding about 100 ppm of the calcium carbonate; adding between about 0.5 and 1% by weight of the caprolactone monomer; and finally adding about 0.1 percent by weight of the polybutylene succinate.

### Example 2

In this example, a precursor composition for biodegradable polyester is present in a low polymerizer. The composition comprises the ester condensation product of terephthalic acid and a stoichiometric amount of ethylene glycol; between about 0.5 and 1% by weight of caprolactone monomer; about 100 ppm by weight of calcium carbonate; and about 0.1% by weight of the polybutylene succinate.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1. A method of spinning a biodegradable polyester copolymer filament, the method comprising:
polymerizing terephthalic acid, ethylene glycol, caprolactone monomer, calcium carbonate, and polybutylene succinate to form a biodegradable polyester copolymer melt; and
spinning the biodegradable polyester copolymer melt into the biodegradable polyester copolymer filament.

2. The method of claim 1, wherein polymerizing terephthalic acid, ethylene glycol, caprolactone monomer, calcium carbonate, and polybutylene succinate to form a biodegradable polyester copolymer melt is carried out on a continuous polymerization line.

3. The method of claim 1, wherein polymerizing terephthalic acid, ethylene glycol, caprolactone monomer, calcium carbonate, and polybutylene succinate to form a biodegradable polyester copolymer melt is carried out on a batch reactor.

4. The method of claim 1, wherein polymerizing terephthalic acid, ethylene glycol, caprolactone monomer, calcium carbonate, and polybutylene succinate comprises polymerizing from about 83% to about 86% terephthalic acid by weight of the biodegradable polyester copolymer melt.

5. The method of claim 1, wherein polymerizing terephthalic acid, ethylene glycol, caprolactone monomer, calcium carbonate, and polybutylene succinate comprises polymerizing from about 13% to about 16% ethylene glycol by weight of the biodegradable polyester copolymer melt.

6. The method of claim 1, wherein polymerizing terephthalic acid, ethylene glycol, caprolactone monomer, calcium carbonate, and polybutylene succinate comprises polymerizing from about 0.3% to about 2.5% caprolactone monomer by weight of the biodegradable polyester copolymer melt.

7. The method of claim 1, wherein polymerizing terephthalic acid, ethylene glycol, caprolactone monomer, calcium carbonate, and polybutylene succinate comprises polymerizing from about 0.01% to about 0.03% calcium carbonate by weight of the biodegradable polyester copolymer melt.

8. The method of claim 1, wherein polymerizing terephthalic acid, ethylene glycol, caprolactone monomer, calcium carbonate, and polybutylene succinate comprises polymerizing from about 0.05% to about 0.25% polybutylene succinate by weight of the biodegradable polyester copolymer melt.

9. The method of claim 1, wherein terephthalic acid, ethylene glycol, caprolactone monomer, calcium carbonate, and polybutylene succinate are polymerized at a temperature from about 270° C. to about 295° C.

10. A method of forming a textured biodegradable polyester copolymer filament, the method comprising texturing the biodegradable polyester copolymer filament produced by the method of claim 1 to form the textured biodegradable polyester copolymer filament.

11. A method of forming a textured biodegradable polyester copolymer staple fiber, the method comprising cutting the textured biodegradable polyester copolymer filament of claim 10 to form a textured biodegradable polyester copolymer staple fiber.

12. A method of forming a textured biodegradable polyester chip, the method comprising granulizing the textured biodegradable polyester copolymer of claim 10 to form a textured biodegradable polyester chip.

13. A method of forming a textured biodegradable polyester container, the method comprising blow-molding the textured biodegradable polyester copolymer of claim 10 to form a textured biodegradable polyester container.

14. A method of forming a textured biodegradable polyester wrap, the method comprising blow-molding the textured biodegradable polyester copolymer of claim 10 to form a textured biodegradable polyester wrap.

15. A method of forming a textured biodegradable polyester copolymer yarn, the method comprising spinning the textured biodegradable polyester copolymer staple fiber of claim 11 to form a yarn.

16. A method of forming a textured biodegradable polyester copolymer blended yarn, the method comprising spinning the textured biodegradable polyester copolymer staple fiber of claim 11 with one or more of cotton fiber and rayon fiber to form a blended yarn.

17. A method of forming a fabric from the textured biodegradable polyester copolymer staple fiber of claim 11.

18. The method of claim 17, wherein forming the fabric comprises knitting the textured biodegradable polyester copolymer staple fiber to form the fabric.

19. The method of claim 17, wherein forming the fabric comprises weaving the textured biodegradable polyester copolymer staple fiber to form the fabric.

20. The method of claim 17, wherein forming the fabric comprises laying a nonwoven batt.

21. A method of forming a garment from the fabric of claim 17.

22. A method of forming a fabric from the biodegradable polyester copolymer filament of claim 1.

23-53. (canceled)
